(19) United States
(12) Patent Application Publication
(10) Pub. No.: US 2018/0262039 A1
(43) Pub. Date: Sep. 13, 2018

(54) CHARGING-POWER TRANSFER SCHEDULING APPARATUS AND METHOD FOR CONTROLLING THE SAME IN WIRELESS CHARGING SYSTEM

(71) Applicant: SAMSUNG ELECTRONICS CO., LTD., Suwon-si (KR)

(72) Inventors: Bonhyun KOO, Suwon-si (KR); Taewon AHN, Suwon-si (KR)

(21) Appl. No.: 15/612,201

(22) Filed: Jun. 2, 2017

(30) Foreign Application Priority Data
Mar. 10, 2017 (KR) 10-2017-0030356

(51) Int. Cl. H02J 7/02; H02J 50/80

(52) U.S. Cl. CPC H02J 7/025; H02J 50/80

(57) ABSTRACT

A method and apparatus for scheduling power transfer of a plurality of power supplies under the control of a power management device is provided. A scheduling method of a power management device for use in in a wireless charging system includes receiving status information from at least one power supply, scheduling power transfer to the at least one power supply based on the status information, and transferring power to the at least one power supply wirelessly based on the scheduling result.

### CROSS-REFERENCE TO RELATED APPLICATION

This application is based on and claims priority under 35 U.S.C. § 119 to a Korean patent application filed on Mar. 10, 2017 in the Korean Intellectual Property Office and assigned Serial number 10-2017-0030356, the disclosure of which is incorporated by reference herein in its entirety.

### TECHNICAL FIELD

The present disclosure relates generally to a charging power transfer scheduling control apparatus and method for a wireless charging system and, for example, to a method and apparatus for scheduling power transfer of a plurality of power supplies under the control of a power management device.

### BACKGROUND

In order to meet the increasing demand for wireless data traffic since the commercialization of 4G communication systems, the development focus has been on the 5^{th} Generation (5G) or pre-5G communication system. For this reason, the 5G or pre-5G communication system is called a beyond 4G network communication system or post Long Term Evolution (LTE) system. Consideration is being given to implementing the 5G communication system in millimeter wave (mmWave) frequency bands (e.g., 60 GHz bands) to accomplish higher data rates. In order to increase the propagation distance by mitigating propagation loss in the 5G communication system, discussions are underway about various techniques such as beamforming, massive multiple-input multiple-output (MIMO), Full Dimensional MIMO (FD-MIMO), array antenna, analog beamforming, and large scale antenna. Also, in order to enhance network performance of the 5G communication system, developments are underway of various techniques such as evolved small cell, advanced small cell, cloud Radio Access Network (cloud RAN), ultra-dense network, Device to Device (D2D) communication, wireless backhaul, moving network, cooperative communication, Coordinated Multi-Points (CoMP), and interference cancellation. Furthermore, the ongoing research includes the use of Hybrid FSK and QAM Modulation(FQAM) and Sliding Window Superposition Coding (SWSC) as Advanced Coding Modulation (ACM), Filter Bank Multi Carrier (FBMC), Non-Orthogonal Multiple Access (NOMA), and Sparse Code Multiple Access (SCMA).

Meanwhile, the Internet is evolving from a human-centric communication network in which information is generated and consumed by humans to the Internet of Things (IoT) in which distributed things or components exchange and process information. The combination of the cloud server-based Big data processing technology and the IoT begets Internet of Everything (IoE) technology. In order to secure the sensing technology, wired/wireless communication and network infrastructure, service interface technology, and security technology required for implementing the IoT, recent research has focused on sensor network, Machine to Machine (M2M), and Machine Type Communication (MTC) technologies. In the IoT environment, it is possible to provide an intelligent Internet Technology that is capable of collecting and analyzing data generated from connected things to create new values for human life. The IoT can be applied to various fields such as smart home, smart building, smart city, smart car or connected car, smart grid, health care, smart appliance, and smart medical service through legacy Information Technology (IT) and convergence of various industries.

Thus, there are various attempts to apply the IoT to the 5G communication system. For example, the sensor network, Machine to Machine (M2M), and Machine Type Communication (MTC) technologies are implemented by means of 5G communication technologies such as beamforming, MIMO, and array antenna. The application of the aforementioned cloud RAN as a big data processing technology is an example of convergence between the 5G and IoT technologies.

The advent of the IoT has given an impetus to the development of technologies for the realization of services for internetworking various types of devices through a single network. The IoT is a technology that allows all networking-capable devices to communicate with one another and creates opportunities in various fields.

In order to realize IoT services, various types of wearable devices are being introduced in the market. Smart watch and Head-Mounted Display (HMD) are representative wearable devices.

There is much research on how to implement IoT services with wearable devices, and one representative example of IoT services is a building management system applied to a smart building environment implemented with an appliance control service. A technology for collecting peripheral environment information through a wireless sensor network may be included in the building management system.

### SUMMARY

The present disclosure provides a method for scheduling charging power supply of a plurality of coexisting wireless power supplies to improve charging efficiency.

In accordance with an example aspect of the present disclosure, a scheduling method of a power management device is provided for use in a wireless charging system. The method includes receiving status information from at least one power supply, scheduling power transfer to the at least one power supply based on the status information, and transferring power to the at least one power supply wirelessly based on the scheduling.

In accordance with another example aspect of the present disclosure, a power management device is provided for use in a wireless charging system. The power management device includes a transceiver configured to receive status information from at least one power supply and to transfer power to the at least one power supply wirelessly, and a controller configured to schedule power transfer to the at least one power supply based on the status information of the at least one power supply.

In accordance with another example aspect of the present disclosure, a power transfer method of a power supply is provided for use in a wireless charging system. The power transfer method includes transmitting status information to a power management device, receiving power transferred by the power management device wirelessly based on a power transfer scheduling decision based on the status information of the power supply, and charging a charging target device wirelessly with the power received from the power management device.

In accordance with still another example aspect of the present disclosure, a power supply is provided for use in a wireless charging system. The power supply includes a transceiver configured to transmit status information to a power management device, to receive power transferred wirelessly by the power management device based on a power transfer scheduling decision based on the status information of the power supply, and to charge a charging target device wirelessly with the power received from the power management device and a power storage unit configured to store the power received from the power management device.

### BRIEF DESCRIPTION OF THE DRAWINGS

The above and/or other aspects, features and attendant advantages of the present disclosure will become apparent and more readily appreciated from the following detailed description, taken in conjunction with the accompanying drawings, in which like reference numerals refer to like elements, and wherein:

FIG. 1 is a diagram illustrating an example configuration of a wireless charging system according to an example embodiment of the present disclosure;

FIG. 2 is a flowchart illustrating an example power supply procedure under scheduling of a power management device according to an example embodiment of the present disclosure;

FIG. 3 is a flowchart illustrating the power supply status information update process of step S220 of FIG. 2;

FIG. 4 is a flowchart illustrating the power supply scheduling process of step 230 of FIG. 2;

FIG. 5 is a diagram illustrating an example of how to determine power consumption of power supplies in the power supply scheduling method according to an example embodiment of the present disclosure;

FIG. 6 is a flowchart illustrating an example charging power supply procedure of a power supply according to an example embodiment of the present disclosure;

FIG. 7 is a diagram illustrating an example power transfer and signal exchange between a power management device and multiple power supplies according to an example embodiment of the present disclosure;

FIG. 8 is a block diagram illustrating an example configuration of a power management device according to an example embodiment of the present disclosure;

FIG. 9 is a block diagram illustrating an example configuration of a power supply according to an example embodiment of the present disclosure;

FIG. 10 is a diagram illustrating an example configuration of a terminal for use by a wireless charging system user according to an example embodiment of the present disclosure;

FIGS. 11 and 12 are diagrams illustrating example screen displays presenting an integrated power management state of a wireless power charging system comprised of a power management device and power supplies according to an example embodiment of the present disclosure; and

FIG. 13 is a diagram illustrating an example of how a user can plan a wireless charging strategy intuitively based on the per-power supply residual power information displayed on the user's terminal in a situation where the integrated controls system is structured as shown in FIGS. 11 and 12.

### DETAILED DESCRIPTION

Example embodiments of the present disclosure are described in greater detail below with reference to the accompanying drawings. Detailed descriptions of well-known functions and structures incorporated herein may be omitted to avoid obscuring the subject matter of the present disclosure. For the same reason, some elements may be exaggerated, omitted, or simplified in the drawings and, in practice, the elements may have sizes and/or shapes different from those shown in the drawings. The same reference numbers are used throughout the drawings to refer to the same or like parts.

Advantages and features of the present disclosure and methods of accomplishing the same may be understood more readily by reference to the following detailed description of example embodiments and the accompanying drawings. The present disclosure may, however, be embodied in many different forms and should not be construed as being limited to the example embodiments set forth herein. Rather, these example embodiments are provided so that this disclosure will be thorough and complete and will fully convey the concept of the disclosure to those skilled in the art, and the present disclosure will only be defined by the appended claims. Like reference numerals refer to like elements throughout the specification.

It will be understood that each block of the flowcharts and/or block diagrams, and combinations of blocks in the flowcharts and/or block diagrams, can be implemented by computer program instructions. These computer program instructions may be provided to a processor of a general-purpose computer, special purpose computer, or other programmable data processing apparatus to produce a machine, such that the instructions which are executed via the processor of the computer or other programmable data processing apparatus create means for implementing the functions/acts specified in the flowcharts and/or block diagrams. These computer program instructions may also be stored in a non-transitory computer-readable memory that can direct a computer or other programmable data processing apparatus to function in a particular manner, such that the instructions stored in the non-transitory computer-readable memory produce manufacture articles embedding instruction means which implement the function/act specified in the flowcharts and/or block diagrams. The computer program instructions may also be loaded onto a computer or other programmable data processing apparatus to cause a series of operational steps to be performed on the computer or other programmable apparatus to produce a computer implemented process such that the instructions which are executed on the computer or other programmable apparatus provide steps for implementing the functions/acts specified in the flowcharts and/or block diagrams.

Furthermore, the respective block diagrams may illustrate parts of modules, segments, or codes including at least one or more executable instructions for performing specific logic function(s). Moreover, it should be noted that the functions of the blocks may be performed in a different order in several modifications. For example, two successive blocks may be performed substantially at the same time, or may be performed in reverse order according to their functions.

The term “module” according to the embodiments of the disclosure may refer, for example, to, but is not limited to, a software or hardware component or any combination thereof (such as a Field Programmable Gate Array (FPGA) and Application Specific Integrated Circuit (ASIC)) which performs certain tasks. A module may advantageously be configured to reside on the addressable storage medium and configured to be executed on one or more processors. Thus, a module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and modules may be combined into fewer components and modules or further separated into additional components and modules. In addition, the components and modules may be implemented such that they execute one or more CPUs in a device or a secure multimedia card. In an embodiment, the term “module” may include one or more processors.

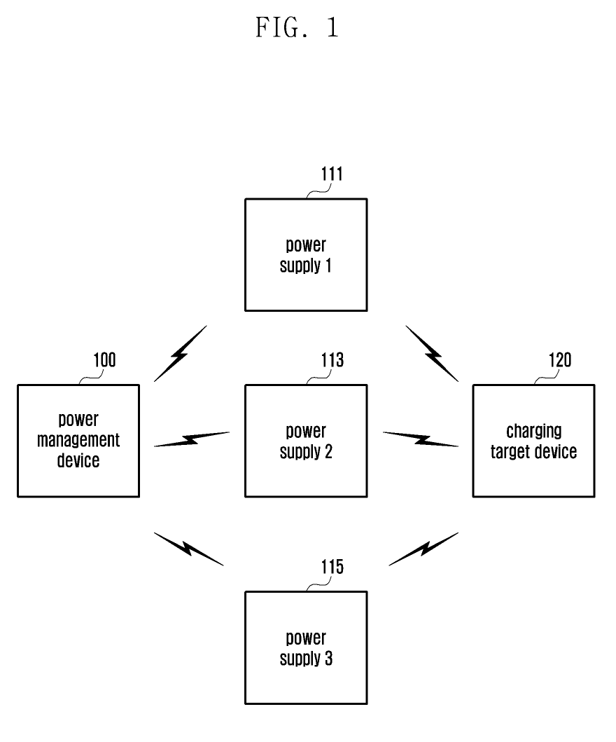

FIG. 1 is a diagram illustrating an example configuration of a wireless charging system according to an example embodiment of the present disclosure.

In an embodiment of the present disclosure, a power management device is capable of scheduling power transfer of at least one power supply. The wireless charging system configured as illustrated in FIG. 1 includes a power management device 100, a plurality of power supplies 111, 113, and 115, and a charging target device 120.

That is, the present disclosure discloses a method for scheduling power transfer of the power supplies 111, 113, and 115 that are capable of charging the charging target device 120 under the control of the power management device 100.

In conventional wireless charging systems, the power supplies operate without any scheduling mechanism. Accordingly, in conventional wireless charging systems it is not efficient to charge a charging target device using multiple power supplies, as those illustrated in FIG. 1.

In order to accomplish the objects of the present disclosure, the present disclosure provides a method for scheduling power transfer of multiple power supplies based on the status of each of the power supplies (including consumption power and power transfer directions of the power supplies).

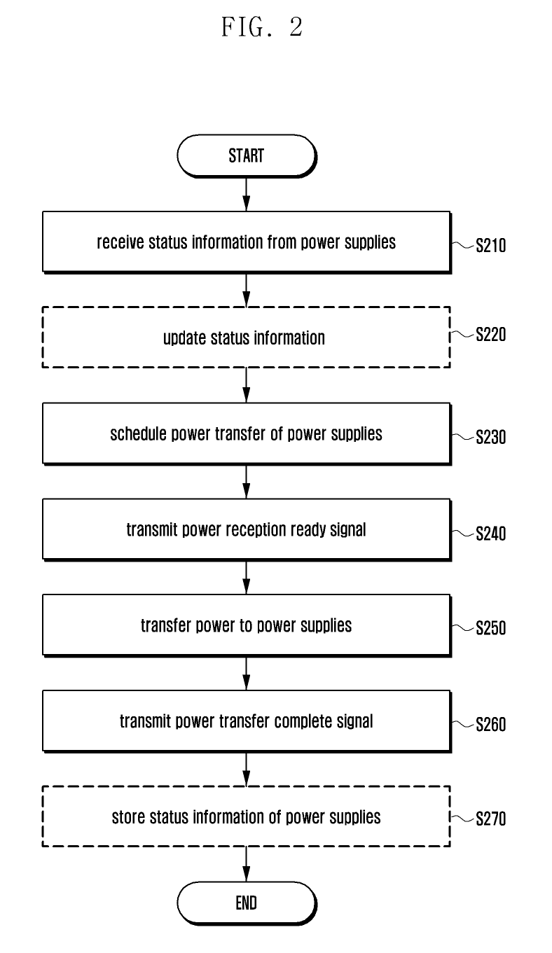

FIG. 2 is a flowchart illustrating an example power supply procedure under scheduling of a power management device according to an example embodiment of the present disclosure.

The power management device receives status information from at least one power supply at step S210. As aforementioned, the status information is the information provided by the at least one power supply for use in scheduling power transfer thereof, and it may include various types of information related to the power supply by the at least one power supply. The status information may include at least one of power consumption, power transfer direction, and residual power.

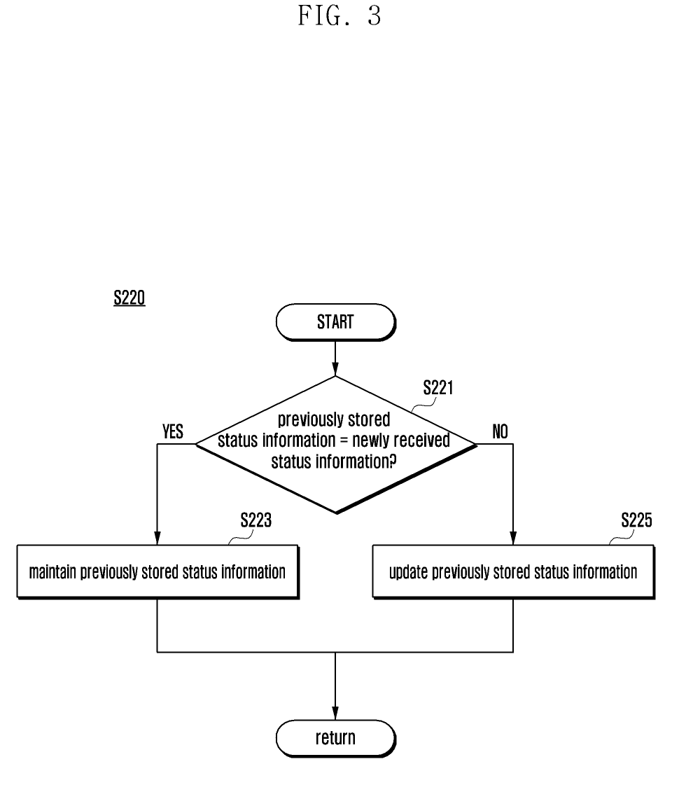

Afterward, the power management device may perform an update operation at step S220, which is optional. If the status information per power supply that is received at step S220 is different from the corresponding status information stored previously, the power management device may update the status information of the corresponding power supply with the newly received status information to improve scheduling accuracy. A detailed description thereon is made later with reference to FIG. 3.

Next, the power management device may schedule the power transfer of each power supply at step S230 based on the status information. As aforementioned, if the status information received from each power supply includes the information on its power consumption, the power management device may perform the scheduling based on the consumption power.

The power consumption indicates the electrical power consumed by a power supply per hour. The power consumption may vary depending on the type and operation mechanism of the power supply. For example, if the power supply is a real-time power supply capable of monitoring a charging target device and transferring power continuously, its power consumption is likely to be high. Meanwhile, if the power supply is a time sleep-enabled power supply, its power consumption is likely to be lower than that of the real-time power supply.

However, the power consumption of a power supply disclosed in the present disclosure may be the power supplied to a charging target device excluding the power consumed for detection of the charging target device.

For example, the power management device may perform scheduling based on the result of a comparison between the power consumptions of the power supplies and a maximum power consumption of the power management device. For example, if the power consumption of the power supplies 1, 2, and 3 is 60 W, 80 W, and 100 W, respectively, and the maximum power consumption of the power management device is 250 W, the sum of the power consumption of the power supplies 1, 2, and 3 is less than the maximum power consumption of 250 W of the power management device. In this case, the power management device controls the power supplies 1, 2, and 3 to output power at the levels of 60 W, 80 W, and 100 W, respectively, without power adjustment.

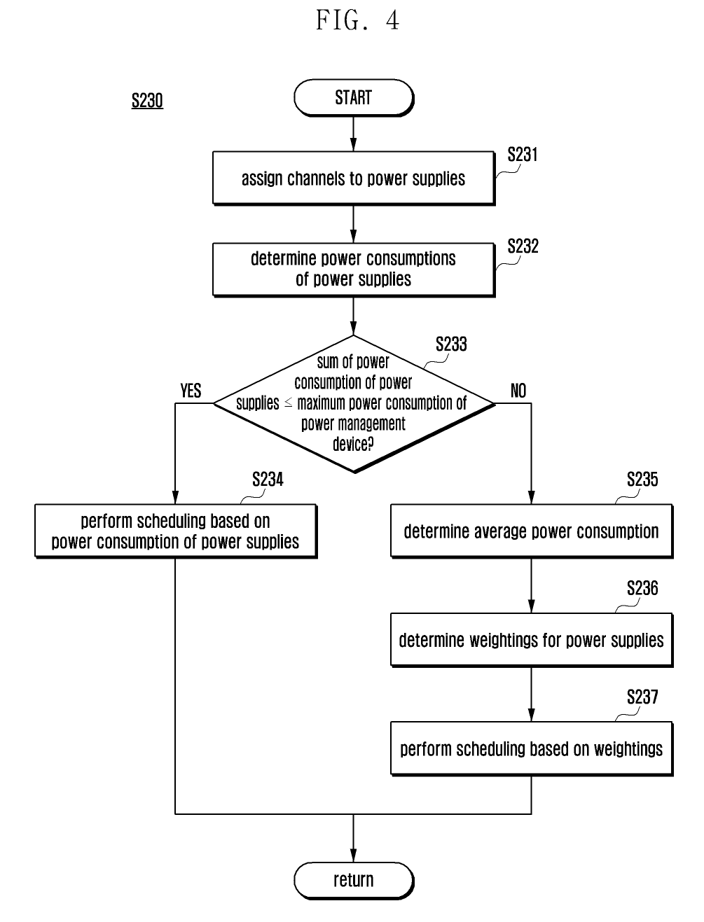

Meanwhile, if the maximum power consumption of the power management device is 200 W while the power supplies have the same power consumption as above, the sum of the power consumption of the power supplies 1, 2, and 3 is greater than the maximum power consumption of the power management device. In this case, the power management device has to perform power supply scheduling by adjusting the power transfer of the respective power supplies. A detailed description of the power adjustment procedure is made later with reference to FIG. 4.

At step S240, the power management device sends the power supplies a power reception ready signal including wakeup information based on the scheduling result determined at step S230. The power reception ready signal is transmitted in order for each power supply to prepare in advance for receiving power from the power management device.

If the power supplies are prepared for receiving power supply based on the power reception ready signal, the power management device starts suppling power to the power supplies at step S250.

If a power supply time scheduled by the power management device elapses, the power management device stops transferring power. In order to notify the end of power transfer, the power management device sends the power supplies a power transfer complete signal at step S260.

The power transfer complete signal may include power transfer complete time information and power supply time information indicating a scheduled subsequent power supply time.

After sending the power transfer complete signal at step S260, the power management device ends the power supply procedure. However, the power management device may further perform the operation of step S270. At step S270, the power management device stores the information of the status of the respective power supplies at the power supply end time point, the status information being received from the respective power supplies at step S210.

The operation of step S270 is required for the per-power supply status information update operation of step S220; thus, it may be performed optionally depending on whether the operation step S220 is performed or not, in accordance with the embodiment.

FIG. 3 is a flowchart illustrating an example power supply status information update process of step S220 of FIG. 2.

As described above, it may be necessary for the power management device to update the status information of the power supplies in order to improve scheduling-based power management efficiency.

This is because the power supply scheduling is performed based on the status information of the power supplies. The more accurate the power supply status information, the higher the efficiency of the scheduling-based power management.

In order to achieve this, the power management device compares previously stored status information and newly received status information at step S221. If the previously stored status information and the newly received status information are identical with each other, there is no need of updating the information; thus, the power management device maintains the previously stored status information at step S223.

Otherwise, if the previously stored status information and the newly received status information are different from each other, the power management device updates the status information at step S225. That is, the power management device updates the previously stored status information with the newly received status information.

Although the embodiment of FIG. 3 disclosures a method for updating the status information depending on whether a previously stored status information and the newly received status information are identical with each other, it may also be possible to compare the rate of change of the status information with a predetermined threshold to determine whether to update the status information.

Here, the threshold is a parameter for determining the necessity of an update. If a status information update is performed, even when a radio communication channel condition is so bad as to distort the channel status information, this may increase the processing load unnecessarily and may be avoided by setting the threshold to an appropriate value.

For example, if the threshold is set to 5% and if the power consumption included in the previously stored status information and the newly received status information are 100 W and 99 W, respectively, the rate of change of the status information is 1%. In this case, since the status information change rate is less than the threshold value, the power management device does not update the previously stored status information.

Otherwise, if the power consumption included in the newly received status information is 110 W, the status information change rate is 10% and, in this case, the power management device updates the previously stored status information with the newly received status information.

FIG. 4 is a flowchart illustrating an example power supply scheduling process of step 230 of FIG. 2.

As aforementioned, the power supply scheduling may be performed in various manners. The embodiment of FIG. 4 is directed to a status information-based scheduling method.

At step 231, the power management device assigns a channel per power supply based on the status information received from the power supplies. As described above, the status information may include power consumption and power transfer directions of power supplies, and the channel is configured for transferring power and the power reception ready signal and power transfer complete signal.

A description is made of the method for assigning channels based on the directions of the power supplies to help understand the status information-based channel assignment process. However, this is just one embodiment of the present disclosure and does not limit the scope of the present disclosure.

In the case where three separately located power supplies transfer power to a charging target device, their power transfer directions may differ from each other.

For example, power supply 1 may transfer power at an angle of 40° to the horizontal and 50° to the vertical, power supply 2 may transfer power at an angle of 40° to the horizontal and 130° to the vertical, and power supply 3 may transfer power at an angle of 20° to the horizontal and 50° to the vertical.

Upon receipt of the power transfer direction information, the power management device may check the presence of the three power supplies as targets to be scheduled and assigns a channel per power supply (e.g., channel 1 to power supply 1, channel 2 to power supply 2, and channel 3 to power supply 3).

Although only the horizontal and vertical directions are used as the power transfer direction information for channel assignment in the above description, the power transfer direction information may also include spherical surface coordinates per power supply and pan & tilt angles.

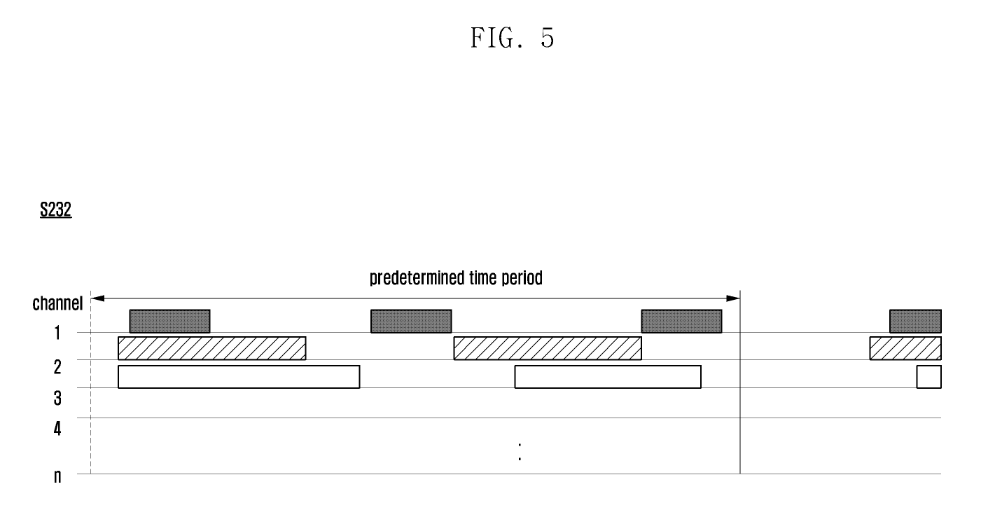

The power management device determines power consumption of the respective power supplies at step S232 based on the signals received through the assigned channels during a predetermined time period. If the status information received from each power supply includes the information on its power consumption, this step may be omitted. The method for determining power consumption of the power supplies is described later in detail with reference to FIG. 5.

Next, the power management device compares the sum of the power consumption of the power supplies and the maximum power consumption of the power management device itself at step S233. As a result of the comparison, if the sum of the power consumption of the power supplies is equal to or less than the maximum power consumption of the power management device, the power management device schedules power transfer of the power supplies based on the power consumption of the power supplies at step S234 as described with reference to FIG. 2.

Otherwise, if the sum of the power consumption of the power supplies is greater than the maximum power consumption of the power management device, it is necessary to adjust the power transfer of the power supplies. This embodiment discloses a method for adjusting the output power of the power supplies using weightings, and step S235 is the first step of a process for determining the weightings.

At step S235, the power management device calculates the average of the power consumption of the power supplies that are determined at step S232. Assuming that per-hour power consumption of power supplies 1, 2, and 3 is 60 W, 80 W, and 100 W, the average power consumption is 80 W.

Next, the power management device determines the weightings to be applied to the respective power supplies at step S236 based on the average power consumption and per-power supply power consumption at step S236.

For example, the weightings may be determined by subtracting the average power consumption from the per-power supply power consumption. Assuming the previous example, the weightings for power supplies 1, 2, and 3 are −20 W, 0 W, and 20 W, respectively.

Next, the power management device schedules the power transfer of the power supplies based on the weightings at step S237.

For example, the power management device divides its maxim power consumption by the number of power supplies to determine maximum allowed transfer power thereof as the first stage for determining the power transfer to the respective power supplies. Assuming that the maximum power transfer of the power management device is 210 W, along with the previous example, the maximum allowed transfer power of the power management device is 70 W (210 W/3).

As the second stage, the power management device adds the weightings determined at step S236 to the maximum allowed output power. Assuming the previous example, the powers allotted to power supplies 1, 2, and 3 are 50 W (70 W+(−20 W)), 70 W (70 W+0 W), and 90 W (70 W+20 W), respectively.

The power management device schedules the power transfer of the power supplies based on the powers allotted to the respective power supplies. Assuming the previous example, power supply 1 may output power during the first 5 seconds, power supply 2 during the subsequent 7 seconds, and power supply 3 during the next subsequent 9 seconds. However, this is just one embodiment of the present disclosure and does not limit the scope of the present disclosure.

FIG. 5 is a diagram illustrating an example of how to determine power consumption of power supplies in the power supply scheduling method according to an example embodiment of the present disclosure.

As illustrated in FIG. 5, the power management device receives signals through channels 1, 2, and 3 and this may denote that there are three power supplies. The power management device receives the signals from the power supplies through channels 1, 2, and 3 and uses the signals received during a predetermined time period to determine the power consumption of the power supplies.

With reference to FIG. 5, the signal received through channel 3 has the longest length and the signal received through channel 1 has the shortest length, among the signals received through channels 1, 2, and 3.

That is, the diagram illustrates that the power supply assigned to channel 3 transmits its signal for a longer duration in comparison with the power supplies assigned to channels 1 and 2, and this may denote that the power consumption of the power supply assigned to the channel 3 is greater than that of the power supplies assigned to channels 1 and 2.

The power management device may also determine the power consumption of the power supplies based on electric current information of the power supplies, which is included in the signals received through channels 1, 2, and 3.

For example, it is supposed that that the electric current from the power supplies assigned to channels 1, 2, and 3 is 5 mA, 4 mA, and 6 mA, respectively, and signal flow lengths of the power supplies 1, 2, and 3 are 10 seconds, 20 seconds, and 30 seconds, respectively, within the predetermined period (as aforementioned) of 60 seconds. In this case, the total current amount received through channels 1, 2, and 3 during the predetermined period of 1 hour is 3 A (60*10 seconds*5 mA), 4.8 A (60*20 seconds*4 mA), and 10.8 A (60*30 seconds*6 mA), respectively.

Accordingly, assuming the commercial supply voltage of 220 V, the power consumption of the power supply assigned to channel 1 is 660 W (220 V*3 A) (or 330 W for the case of using the commercial supply voltage of 110 V). Likewise, assuming the commercial supply voltage of 220 V, the power consumption of the power supplies assigned to channels 2 and 3 is 1056 W and 2376 W, respectively.

A specific method for determining power consumption of the power supplies has been disclosed, but this is just an example embodiment and the power management device can calculate the power consumption of the power supplies in various manners.

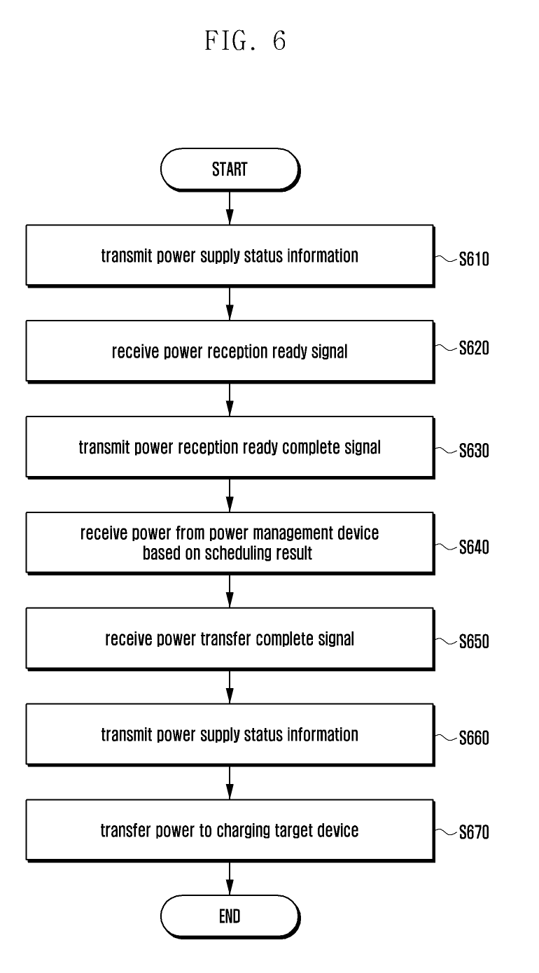

FIG. 6 is a flowchart illustrating an example charging power supply procedure of a power supply according to an example embodiment of the present disclosure.

The power supply transmits its status information to the power management device at step S610. As described above, the status information may include at least one of power consumption and power transfer direction.

The power management device schedules power transfer of the power supply based on the status information; thus, if a scheduling decision is made, the power supply receives a power reception ready signal including wakeup information at step S620 based on the schedule decision.

The power supply prepares for receiving the power from the power management device according to the power reception ready signal (e.g., waking up a controller concerning power reception) and, after completing preparation for receiving power, transmits a power reception ready complete signal to the power management device at step S630.

The power supply receives power wirelessly from the power management device at step S640 based on the scheduling result.

The power supply receives a power transfer complete signal including a power transfer complete time information from the power management device at step S650. The power supply may determine the end time of the power transfer from the power management device and check subsequent power transfer timings.

The power supply transmits to the power management device its status information at step S660 in correspondence with the transfer complete time information. As described above, the status information of the power supply is stored and updated in the power management device.

The power supply supplies power wirelessly to the charging target device at step S670 based on the power transferred from the power management device. In this case, if the power transferred from the power management device is directly supplied to the charging target device, it may be possible for the power management device to schedule the power transfer to the charging target device as well as to the power supplies.

The power transferred from the power management device may be stored in a power storage unit of the power supply to supply the power to the charging target device according to the user's manipulation.

For example, if a plurality of power supplies capable of supplying power to the charging target device display residual power indicators, the user may select one of the power supplies based on the residual power indicators for charging the target device.

In order to perform the wireless charging based on the residual power indication of the power supplies, however, the power supplies may have to transmit their residual power information to the power management device.

This operation may be performed by adding a step at which the power management device requests to the power supplies for residual power information and a step at which the power supplies transmit the residual power information to the power management device in response to the request.

It may also be possible to consider including the residual power information in the status information transmitted from the power supplies to the power management device at step S610.

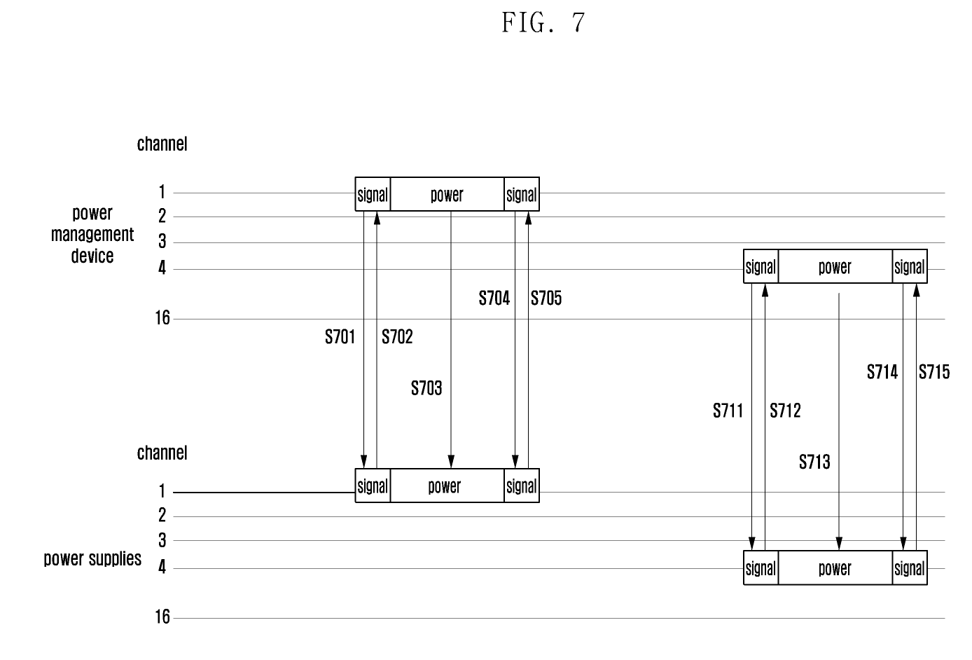

FIG. 7 is a diagram illustrating an example power transfer and signal exchange between a power management device and multiple power supplies according to an example embodiment of the present disclosure.

The power management device communicates various signals with the power supplies and transfers power to the power supplies according to its scheduling decision as illustrated in FIG. 7.

The power management device transmits a power reception-ready signal to the power supply through channel 1 according to the scheduling decision at step S701. If the power supply is ready to receive power from the power management device, it transmits to the power management device a power reception ready complete signal through channel 1 at step S702.

If the power reception ready complete signal is received, the power management device transfers power to the power supply through channel 1 at the scheduled time at step S703.

If the power transfer is completed over channel 1 according to the scheduling result, the power management device transmits to the power supply a power transfer complete signal through channel 1 at step S704.

In response to the power transfer complete signal, the power supply transmits the power supply status information to the power management device through channel 1 at step S705 and, in this case, the power management device may determine whether to update the previously stored power supply status information with the newly received power supply status information.

The power management device may transfer power to one power supply through a process comprised of steps S701, S702, S703, S704, and S705. The power management device may also transfer power to another power supply and, in this case, the power is transferred through channel 4 in the same process as illustrated in steps S711, S712, S713, S714, and S715 of FIG. 7.

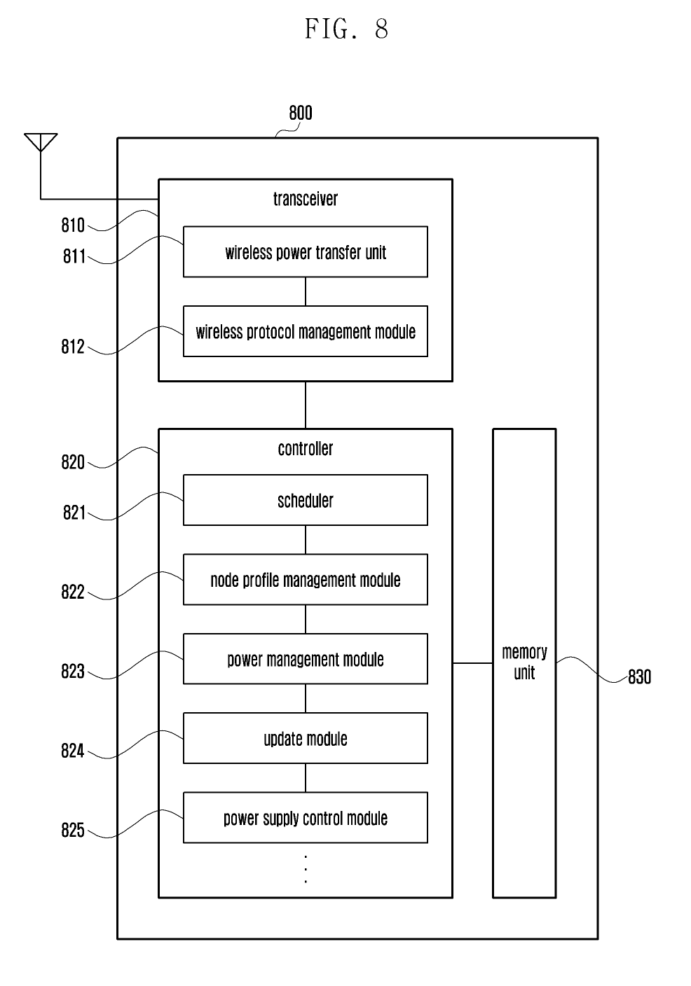

FIG. 8 is a block diagram illustrating an example configuration of a power management device according to an example embodiment of the present disclosure.

According to an embodiment of the present disclosure, the power management device 800 may include a transceiver 810, a controller (e.g., including processing circuitry and/or program elements) 820, and a memory unit 830 for storing status information of power supplies.

The transceiver 810 may include a wireless power transfer unit 811 and a wireless protocol management module 812. The wireless power transfer unit 811 is a module including various circuitry for transferring power wirelessly and may perform hardware and software processing (or a combination thereof) for controlling power supply signal transmission.

The wireless protocol management module 812 is a module including various circuitry and/or program elements for managing radio frequency (RF) communication with the power supplies and may perform protocol encapsulation for exchanging data between the power management device and the power supplies.

The controller 820 may include various program elements, such as, for example, and without limitation, a scheduler 821, a node profile management module 822, a power management module 823, an update module 824, and a power supply control module 825.

The scheduler 821 may control the power transfer direction and the power supplies according to a transmission/reception schedule per power supply node (or channel).

The node profile management module 822 may calculate power transfer durations based on the node (or channel) information collected during a predetermined period and manage the power supply status information using a channel assignment table.

The power management module 823 may manage the power status of the power supplies and, when the power status of any power supply changes during its power transfer duration, update the power status.

The update module 824 may manage the data including the status information of the power supplies and, when any status information changes, update the corresponding status information.

The power supply control module 825 may control the wireless protocol management module 812 as well as the power transfer directions of the power supplies according to the scheduling result of the scheduler 821.

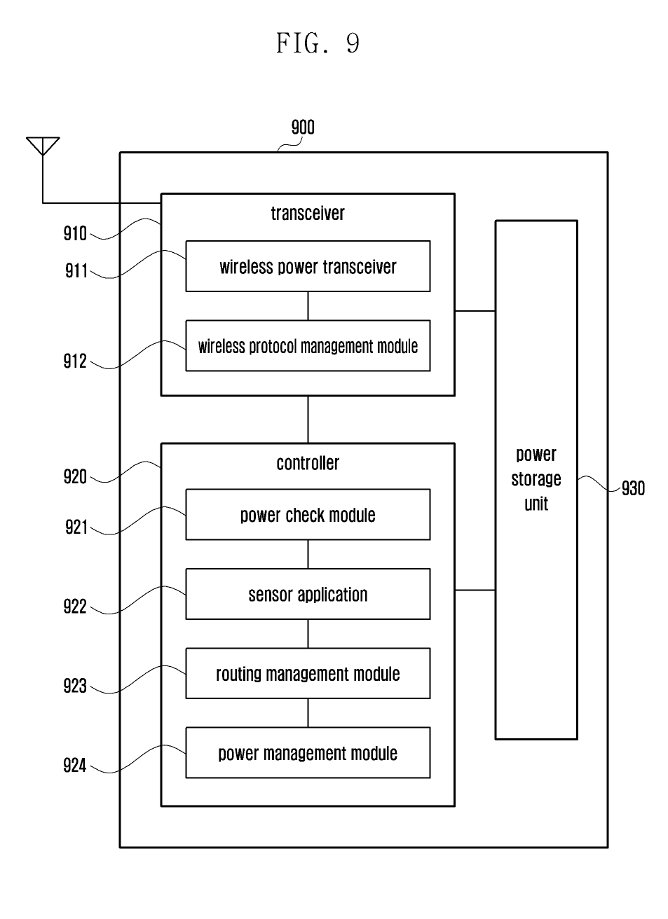

FIG. 9 is a block diagram illustrating an example configuration of a power supply according to an example embodiment of the present disclosure.

According to an embodiment of the present disclosure, the power supply 900 may include a transceiver 910, a controller (e.g., including processing circuitry and/or program elements) 920, and a power storage unit 930 for storing the power transferred from a power management device.

The transceiver 910 may include various circuitry, including, for example, and without limitation, a wireless power transceiver 911 and a wireless protocol management module 920. The wireless power transceiver 911 is a module including various circuitry for receiving power transferred wirelessly from the power management device, and it may charge the power storage unit 930 upon receipt of the power supply signal and supply the power transferred from the power management device to the charging target device.

The wireless protocol management module 912 is a module including various circuitry and/or program elements for managing the RF communication between the power supply and the power management device and may perform protocol encapsulation for exchanging data between the power supply and the power management device.

The controller 920 may include various processing circuitry and/or program elements, such as, for example, and without limitation, a power check module 921, a sensor application 922, a routing management module 923, and a power management module 924.

The power check module 921 may check the residual power of the power supply 900 and transmits the check result to the power management module 924 in order for the power management device to configure a power transfer schedule and profile to the power supply 900.

The sensor application 922 may collect ambient information of the power supply and include application data generated based thereon in a payload field of a signal transmitted to the power management signal for pre-processing on the data in adaptation to the characteristics of the application sensor attached to the power supply 900.

The routing management module 923 is a module for managing a routing path of packets between the power supply 900 and the power management device and has a path to a next hop node; if the power supply 900 is an intermediate node, its routing management module 923 may have a routing table for source-destination (Src-Dst) node matching.

The power management module 924 transmits to the wireless protocol management module 912 the information generated based on the data output by the sensor application 922 and the routing management module 923 and may manage the wakeup and shutdown of the power supply.

The present disclosure discloses a method for a power management device to control power transfer of a plurality of power supplies. The power transfer control method of the present disclosure is capable of improving management convenience of a wireless charging system and makes it possible to present power management information of the wireless charging system on a console of a wireless charging system operator and/or a terminal of a wireless charging system user.

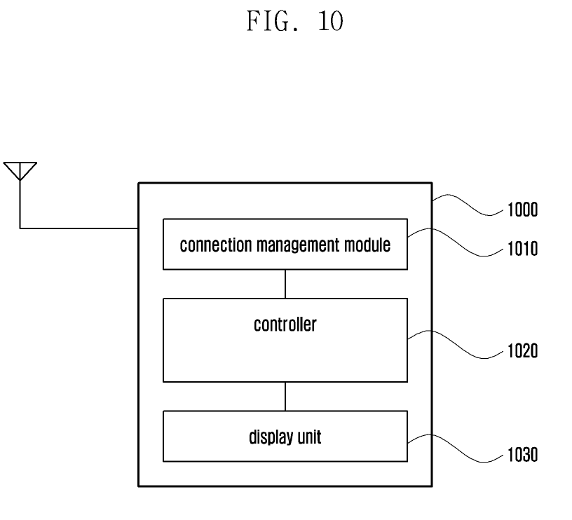

FIG. 10 is a diagram illustrating an example configuration of a terminal for use by a wireless charging system user according to an example embodiment of the present disclosure.

According to an embodiment of the present disclosure, the terminal 1000 may include a connection management module 1010, a controller (e.g., including processing circuitry) 1020, and a display unit (e.g., including a display) 1030. The connection management module 1010 may include various circuitry and/or program elements to receive power management information from a power management device and configure a connection for a visualization process. The connection management module 1010 may transmit a pairing configuration command using a wireless protocol established initially between the power management device and the power supply.

The controller 1020 may include various processing circuitry and request to the power management device for information on a certain power supply, adjust/manage the information request cycle, and receive a user input made on the display unit 1030. The controller 1020 may request for a control message format through the Representational State Transfer (ReST) standard in transmitting a control request corresponding to the user input to the power management device and perform a visualization process on the data received in reply.

The display unit 1030 may include a display and process the data received from the power management device to display it finally as a graphic image. The display unit 1030 also may receive an input made by the user thereon. That is, the display unit 1030 can be implemented as a touchscreen that is capable of displaying the data received from the power management device in a predetermined data format as well as receiving a user input.

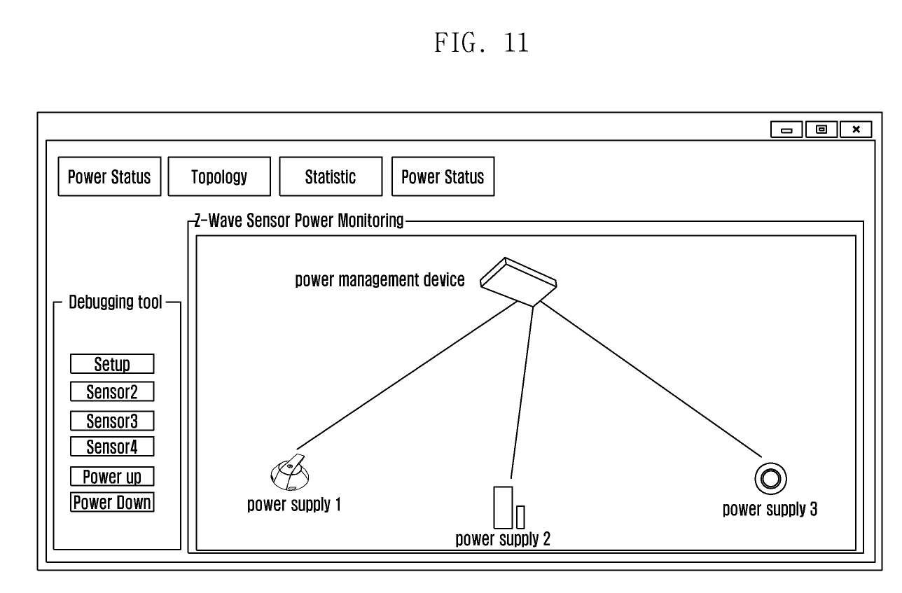

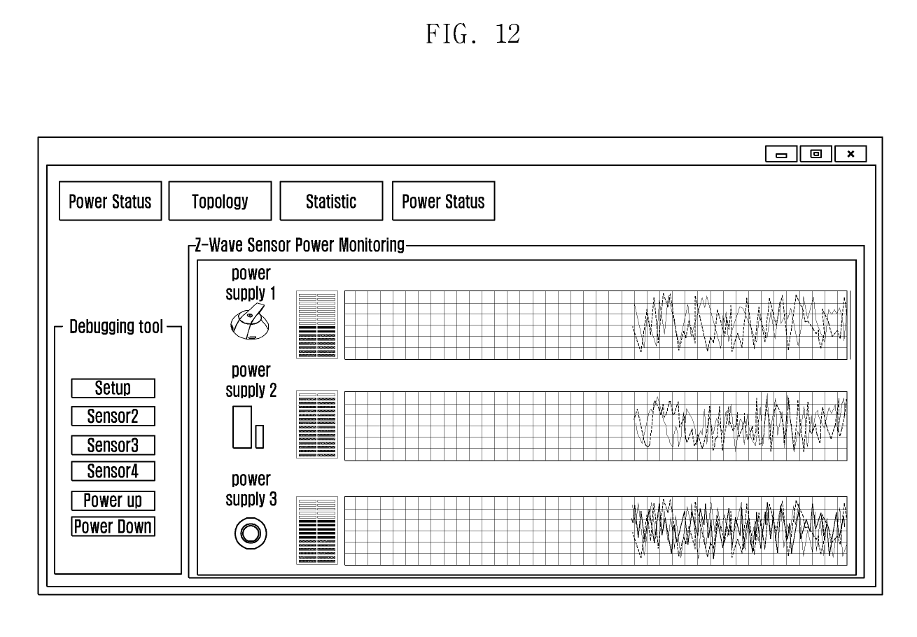

FIGS. 11 and 12 are diagrams illustrating example screen displays presenting an integrated power management state of a wireless power charging system comprising a power management device and power supplies according to an example embodiment of the present disclosure.

FIG. 11 is an example screen display illustrating an overview of a wireless charging system comprising one power management device and three power supplies. The user may check the connections between the power management device and power supplies on the screen as illustrated in FIG. 11 and other information such as residual powers of the respective power supplies and the state of power transfer from the power management device to the power supplies by activating various status display screens.

FIG. 12 is an example screen display illustrating the state of power transfer from the power management device to the power supplies and residual powers of the power supplies in the form of a graph.

The user may check that power supply 2 has the greatest residual power and power supply 1 has the least residual power among the three power supplies on the display screen of FIG. 12. That user may also check the schedule for transferring power to the power supplies on the graph and select the best power supply for charging the charging target device based on the check result.

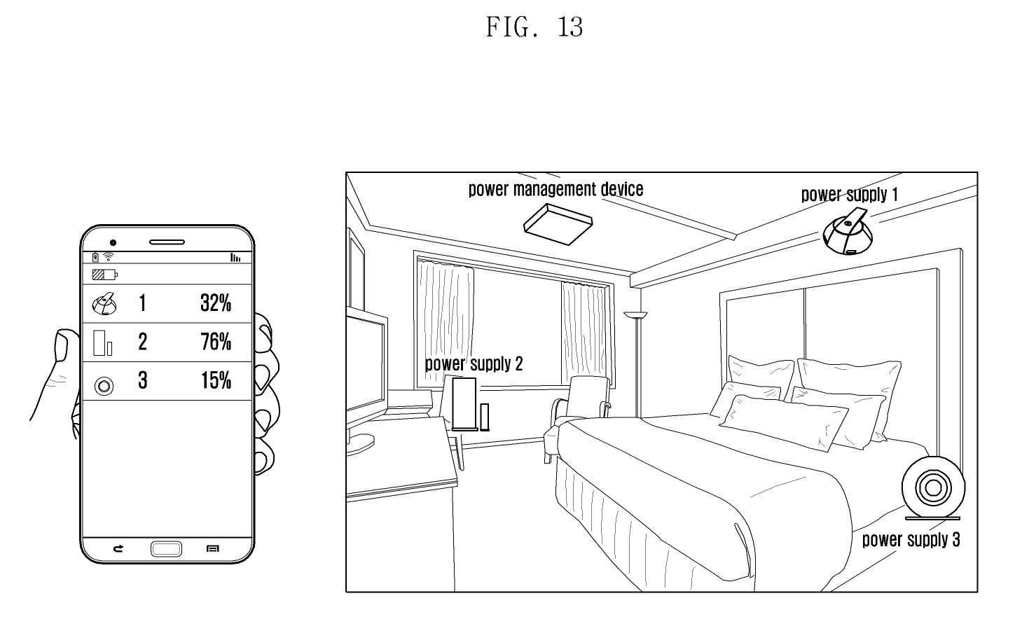

FIG. 13 is a diagram illustrating an example of how a user can plan a wireless charging strategy intuitively based on the per-power supply residual power information displayed on the user's terminal in a situation where the integrated control system is structured as illustrated in FIGS. 11 and 12.

In an example situation where one power management device and three power supplies are deployed in a predetermined space, the user terminal may display the information on the residual powers of the respective power supplies as shown in FIG. 13.

In this state, the user may check that the residual power of power supply 2 is more than that of other power supplies and select power supply 2 for charging the charging target device.

Although FIG. 13 illustrates a case where the user selects one of the power supplies based on the per-power supply residual powers, it may also be possible for the terminal to display the information on the power consumption of the power supplies or electric current transferred to the power supplies in order for the user to select one of the power supplies based on this information.

As described above, the charging power transfer scheduling method and apparatus of the present disclosure is advantageous in terms of improving charging efficiency and utilization convenience of a wireless charging system by allowing a power management device to schedule the charging power supply in consideration of the residual powers of the respective power supplies.

Although various example embodiments of the disclosure have been described using specific terms, the specification and drawings are to be regarded in an illustrative rather than a restrictive sense in order to help understand the present disclosure. It will be apparent to those skilled in the art that various modifications and changes can be made thereto without departing from the broader spirit and scope of the disclosure. If necessary, the embodiments may be combined in whole or in part. It will be apparent to those skilled in the art that the various example embodiments may be combined in various ways to form other alternative embodiments without departing from the spirit and scope of the present disclosure.

What is claimed is:

1. A scheduling method of a power management device in a wireless charging system, the method comprising:
receiving status information from at least one power supply;
scheduling power transfer to the at least one power supply based on the status information; and
transferring power to the at least one power supply wirelessly based on the scheduling.

2. The method of claim 1, wherein the status information comprises power consumption of the at least one power supply, and scheduling the power transfer comprises:
comparing a maximum power consumption of the power management device and the power consumption of the at least one power supply; and
scheduling the power transfer based on the comparison.

3. The method of claim 1, wherein scheduling the power transfer comprises:
assigning a channel to the at least one power supply based on the status information;
determining power consumption of the at least one power supply based on a signal received through the channel during a predetermined period; and
scheduling the power transfer to the at least one power supply based on a result of comparison between a maximum power consumption of the power management device and the power consumption of the at least one power supply.

4. The method of claim 3, wherein scheduling the power transfer comprises scheduling, when a sum of the power consumption of the at least one power supply is equal to or less than the maximum power consumption of the power management device, the power transfer based on the power consumption of the at least one power supply.

5. The method of claim 3, wherein scheduling the power transfer comprises:
determining, when the sum of the power consumption of the at least one power supply is greater than the maximum power consumption of the power management device, an average of the power consumption of the at least one power supply based on the power consumption of each power supply;
determining a maximum allowed transfer power by dividing the maximum power consumption of the power management device by a number of the at least one power supply;
determining the power to be transferred to the at least one power supply by adding a weighting to the maximum allowed transfer power, the weighting being obtained by subtracting the average power consumption from the power consumption of each power supply;
determining a weighting for the at least one power supply based on the average power consumption and the power consumption of each power supply; and
scheduling the power transfer to the at least one power supply based on the weighting.

6. The method of claim 1, further comprising transmitting, before transferring the power, a power reception ready signal including wakeup information to the at least one power supply based on the scheduling.

7. The method of claim 1, further comprising:
transmitting, after transferring the power, a power transfer complete signal including transfer complete time information, to the at least one power supply based on the scheduling;
storing the status information of the at least one power supply at a transfer end time;
comparing the status information received newly from the at least one power supply after storing the status information with the previously stored status information; and
updating the previously stored status information with the newly received status information, when the newly received status information and the previously stored status information are different from each other.

8. A power management device for use in a wireless charging system, the device comprising:
a transceiver configured to receive status information from at least one power supply and to transfer power to the at least one power supply wirelessly; and
a controller configured to schedule power transfer to the at least one power supply based on the status information of the at least one power supply.

9. The power management device of claim 8, wherein the status information comprises power consumption of the at least one power supply, and the controller is configured to compare a maximum power consumption of the power management device and the power consumption of the at least one power supply and to schedule the power transfer based on the comparison.

10. The power management device of claim 8, wherein the controller is configured to assign a channel to the at least one power supply based on the status information, to determine power consumption of the at least one power supply based on a signal received through the channel during a predetermined period, and to schedule the power transfer to the at least one power supply based on a result of comparison between a maximum power consumption of the management device and the power consumption of the at least one power supply.

11. The power management device of claim 10, wherein the controller is configured to schedule the power transfer based on the power consumption of the at least one power supply, when a sum of the power consumption of the at least one power supply is equal to or less than the maximum power consumption of the power management device.

12. The power management device of claim 10, wherein the controller is configured to determine an average power consumption of the at least one power supply based on the power consumption of each power supply, when the sum of the power consumption of the at least one power supply is greater than the maximum power consumption of the power management device, to determine a weighting for the at least one power supply based on the average power consumption and the power consumption of each power supply, to schedule the power transfer to the at least one power supply based on the weighting, to determine a maximum allowed transfer power by dividing the maximum power consumption of the power management device by a number of the at least one power supply and to determine the power to be transferred to the at least on power supply by adding a weighting to the maximum allowed transfer power, the weighting being obtained by subtracting the average power consumption from the power consumption of each power supply.

13. The power management device of claim 8, wherein the transceiver is configured to transmit, before transferring the power, a power reception ready signal including wakeup information to the at least one power supply based on the scheduling, and to transmit, after transferring the power, a power transfer complete signal including transfer complete time information, to the at least one power supply based on the scheduling.

14. The power management device of claim 8, further comprising a memory for storing the status information of the at least one power supply, wherein the controller is configured to compare the status information received newly from the at least one power supply after storing the status information in the memory with the previously stored status information and to update, when the newly received status information and the previously stored status information are different from each other, the previously stored status information with the newly received status information.

15. A power transfer method of a power supply in a wireless charging system, the method comprising:
transmitting status information to a power management device;
receiving power transferred by the power management device wirelessly based on a power transfer scheduling based on the status information of the power supply; and
charging a charging target device wirelessly with the power received from the power management device.

16. The method of claim 15, wherein the status information comprises power consumption of the power supply, and the power supply receives the power transferred by the power management device determined based on a result of a comparison between a maximum power consumption of the power management device and the power consumption of the power supply.

17. The method of claim 15, wherein receiving the power comprises:
transmitting a signal for determining power consumption of the power supply to the power management device through a channel assigned based on the status information; and
receiving the power from the power management device wirelessly based on a power transfer scheduling based on a result of comparison between a maximum power consumption of the power management device and the power consumption of the power supply, the power consumption of the power supply being determined based on the signal.

18. The method of claim 15, further comprising:
receiving, before receiving the power, a power reception ready signal including wakeup information from the power management device based on a scheduling by the power management device;
preparing to receive power from the power management device;
transmitting a power reception ready complete signal to the power management device;
receiving, after receiving the power, a power transfer complete signal including transfer complete time information from the power management device based on a scheduling by the power management device;
transmitting the status information of the power supply at a power transfer complete time to the power management device;
receiving a residual power request signal from the power management device; and
transmitting a residual power response signal including residual power information of the power supply to the power management device.

19. A power supply for use in a wireless charging system, the power supply comprising:
a transceiver configured to transmit status information to a power management device, to receive power transferred wirelessly by the power management device based a power transfer scheduling based on the status information of the power supply, and to charge a charging target device wirelessly with the power received from the power management device; and
a power storage unit configured to store the power received from the power management device.

20. The power supply of claim 19, wherein the transceiver is configured to transmit a signal for determining power consumption of the power supply to the power management device through a channel assigned based on the status information and to receive the power from the power management device wirelessly based on a power transfer scheduling based on a result of the comparison between a maximum power consumption of the power management device and the power consumption of the power supply.
